(19) United States
(12) Patent Application Publication
(10) Pub. No.: US 2003/0150675 A1
(43) Pub. Date: Aug. 14, 2003

(54) Hydraulic brake caliper having dry assembly

(75) Inventors: John A. Hart, Middletown, OH (US); Natalies S. Donahue, New Carlisle, OH (US); Andrew F. Hall, Dayton, OH (US); William Cornwell, Beavercreek, OH (US)

Correspondence Address: DELPHI TECHNOLOGIES, INC., Legal Staff, Mail Code 482-204-450, 1450 W. Long Lake, P.O. Box 5052, Troy, MI, 48098, US

(73) Assignee: DELPHI TECHNOLOGIES INC.

(21) Appl. No.: 10/074,911

(22) Filed: Feb. 11, 2002

(51) Int. Cl. F16D 55/00

(52) U.S. Cl. 188/73.31

(57) ABSTRACT

A caliper for a motor vehicle braking system comprises a housing having a bore, and a piston slidable in the bore. A groove is formed in one of the housing or the piston, and a seal is disposed in the groove. The seal has a dry lubricant coating.

### TECHNICAL FIELD OF THE INVENTION

The present invention relates generally to dynamic brakes for motor vehicles, and more particularly to a hydraulic brake caliper having dry assembly.

### BACKGROUND OF THE INVENTION

A brake system for a motor vehicle, and in particular an automotive vehicle, functionally reduces the speed of the vehicle or maintains the vehicle in a rest position. Hydraulic brake systems are most commonly used in automotive vehicles. In a hydraulic brake system, the hydraulic fluid transfers energy from a brake pedal to brake pads for slowing down or stopping rotation of a wheel of the vehicle. Certain electronics may also be provided to control the apply rates in the hydraulic brake system.

Traditionally, hydraulic fluid is a very efficient means of transferring a load, since a brake system in an automotive vehicle must be able to transfer relatively large loads. All hydraulic brake caliper assemblies require lubrication of tight sealing areas in order to assemble the parts easily and with no damage to the hydraulic sealing components. This lubrication is commonly done with various forms of liquid silicone.

### SUMMARY OF THE INVENTION

The present invention is a hydraulic caliper for a motor vehicle braking system. The hydraulic caliper comprises a housing, a piston, and a seal. The housing has a bore, and the piston is slidable in the bore. The seal is disposed in a groove formed in one of the housing or the piston. The seal has a dry lubricant coating.

Accordingly, it is an object of the present invention to provide a caliper for a brake system that avoids the use of liquid lubricants.

Another object of the present invention is to provide a caliper of the type described above that reduces the time that machinery used to assemble the caliper is down for maintenance or repair.

Still another object of the present invention is to provide a caliper of the type described above in which the dry lubricant is tinted for easier detection.

These and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a cross sectional schematic view of a caliper according to the present invention; and

FIG. 2 is a cross sectional schematic view of a portion of the caliper shown in FIG. 1.

### DETAILED DESCRIPTION OF THE PRESENTLY PREFERRED EMBODIMENT

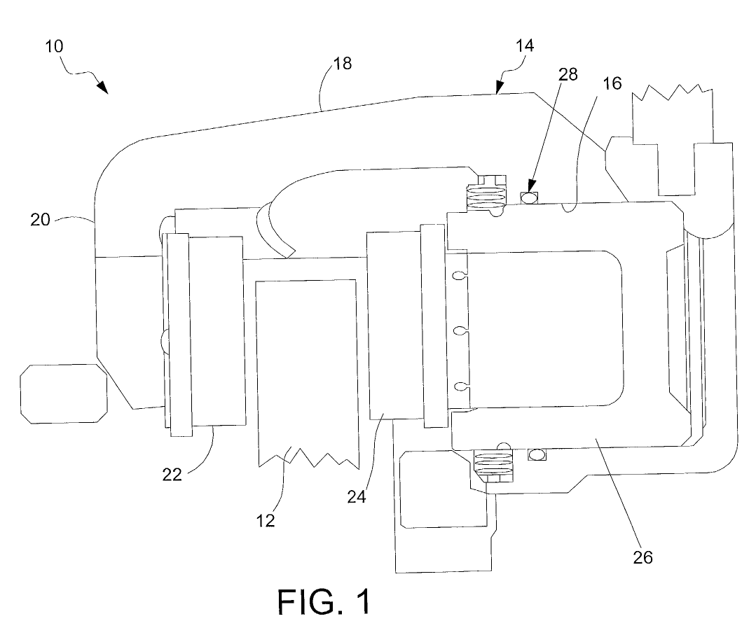

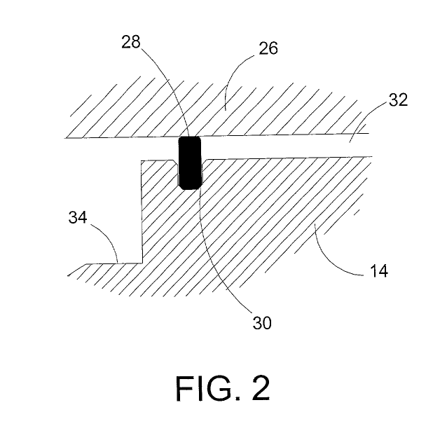

FIGS. 1 and 2 show one embodiment of a hydraulic caliper 10 according to the present invention for a brake system such as of the disc brake type to slow or stop rotation of a wheel (not shown) of a motor vehicle. The brake system includes a brake pedal (not shown) that communicates a signal from a driver of the motor vehicle to the caliper 10. Rotation of a disc or rotor 12 is slowed down or stopped by engaging the caliper 10, which displaces a pair of resilient friction elements that engage the disc 12 as described below.

The caliper 10 includes a housing 14 having a bore 16 and an L-shaped bridge 18 extending transversely from a front end of the housing 14. The bridge 18 has a leg 20 to move or displace an outer brake pad 22 as will be described. The caliper 10 also includes an inner brake pad 24 extending radially from an inner attachment bracket leg closest to the housing 14. The disc 12 extends between the outer and inner brake pads 22 and 24.

In this example, the caliper 10 is of the bracketed type. Thus, the housing 14 is transversely slidable supporting pins (not shown). A piston 26 is disposed in the bore 16. During braking, the piston 26 slides leftwardly as shown in FIG. 1 and urges the inner brake pad 24 into engagement with the disc 12. The resulting reactionary force on the sliding housing pulls the outer brake pad 22 into engagement with the disc 12. The engagement of the inner and outer brake pads with the disc 12 decelerates the wheel or holds the wheel in a fixed position.

FIG. 2 shows an elastomeric seal 28 disposed in a groove 30 in the bore 16 of the caliper housing. It should be appreciated, of course, that the groove in which the seal 28 is situated alternately may be formed in the outside diameter of the piston 26. In either event, the seal 28 separates a small vacuum path 32 from an outlet to ambient air proximate a boot sealing surface 34. The seal 28 is coated with a dry lubricant such as a fluropolymer commonly known as Teflon®.

The dry coating on the piston seals allows the hydraulic components of the caliper 10, such as the insertion of the piston 26 into the bore 16, to be assembled without a liquid lubricant such as silicone. The dry coating is preferably tinted so as to have a color distinguishable from the color of the parts of the caliper to which it is applied. This discoloration enhances the ability to monitor application of the dry coating before and during installation.

The elimination of the application of a liquid lubricant during manufacture results in a cleaner assembly environment. In particular, dry assembly according to the present invention reduces the incidence of machining chips, which may be present in the assembly environment, from invading into the caliper with a liquid lubricant and causing problems such as leaks. Moreover, both the finished calipers and the machinery used to assembly them are kept free from excess lubricant. This is particularly significant in preventing any liquid lubricant from mixing with the brake fluid.

The absence of a liquid lubricant reduces fluid invasion into testing equipment. For example, an evacuation and fill tester or station may be used during assembly to evacuate the entire brake system via the master cylinder. When the desired vacuum level is reached, the machine fills the brake system with brake fluid. The machine then simulates a brake apply in order to create a travel and pressure plot to determine if the system is operating within tolerances. By reducing the incidence of contact between a liquid lubricant and the valves and seals of such equipment, the present invention reduces the time that the equipment must be serviced to address problems associated with the intrusion of liquid lubricant.

The dry lubricant also reduces the rate of false positive readings. For instance, small leaks which result from cut seals may not be detected when liquid lubricant fills in the cut area. With the present invention, however, such small cuts are more easily detected because the dry lubricant does not prevent the cut from being detected during testing on the assembly line.

While the embodiment of the invention disclosed herein is presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A brake caliper comprising:
a housing having a bore;
a piston slidable in the bore;
a groove formed in one of the housing or the piston; and
a seal disposed in the groove, the seal having a dry lubricant coating.

2. The caliper of claim 1 wherein the piston is hydraulically actuated.

3. The caliper of claim 1 wherein the seal is an elastomeric seal.

4. The caliper of claim 1 wherein the dry lubricant is a fluropolymer.

5. A brake caliper assembly comprising:
a housing having a bore;
first and second brake pads operatively connected to the housing;
a piston slidable in the bore to actuate the first and second brake pads;
a groove formed in one of the housing or the piston; and
a seal disposed in the groove, the seal having a dry lubricant coating.

6. The brake caliper assembly of claim 5 wherein the piston is hydraulically actuated.

7. The brake caliper assembly of claim 5 wherein the seal is an elastomeric seal.

8. The brake caliper assembly of claim 5 wherein the dry lubricant is a fluropolymer.

9. A brake caliper assembly comprising:
a housing having a bore;
first and second brake pads operatively connected to the housing;
a hydraulically actuated piston slidable in the bore to actuate the first and second brake pads;
a groove formed in one of the housing or the piston; and
an elastomeric seal disposed in the groove, the seal having a fluropolymer coating.
